(19) United States
(12) Patent Application Publication
(10) Pub. No.: US 2011/0153299 A1
(43) Pub. Date: Jun. 23, 2011

(54) METHOD AND APPARATUS FOR SIMULATING VISCOELASTIC FLUID IN SMOOTHED PARTICLE HYDRODYNAMICS BASED FLUID SIMULATION

(76) Inventors: Young Hee Kim, Daejeon (KR); Soon Hyoung Pyo, Daejeon (KR); Bon Ki Koo, Daejeon (KR)

(21) Appl. No.: 12/784,433

(22) Filed: May 20, 2010

(30) Foreign Application Priority Data
Dec. 18, 2009 (KR) 10-2009-0127346

(51) Int. Cl. G06G 7/57

(52) U.S. Cl. 703/9

(57) ABSTRACT

Provided is a method of simulating various viscoelastic fluids having viscosity, elasticity, and plasticity, based on smoothed particle hydrodynamics (SPH), which is widely used in fluid simulation using particles. Artificial forces related with viscosity, elasticity, and plasticity are added to address fundamental numerical limitations of a SPH method due to use of particle approximation and to improve expression of characterized motions of a viscoelastic fluid. Since the artificial forces are added, and parameters are adjusted according to the adding of the artificial forces, a fluid can be realistically expressed, and the control of a fluid motion is facilitated.

### CROSS-REFERENCE TO RELATED APPLICATIONS

This application claims priority under 35 U.S.C. §119 to Korean Patent Application No. 10-2009-0127346, filed on Dec. 18, 2009, the disclosure of which is incorporated herein by reference in its entirety.

### TECHNICAL FIELD

The following disclosure relates to fluid simulation, and in particular, to fluid simulation for a viscoelastic fluid having viscosity, elasticity, and plasticity, based on smoothed particle hydrodynamics (SPH), which is widely used in fluid simulation using particles.

### BACKGROUND

Pure elastic material has the physical property that returns to its original shape after the stress, that made it deform, is removed. Pure viscous materials are linearly resistant to deformation when stress is applied, and dissipates all the energy. Materials other than both pure elastic materials and pure viscous materials are classified as viscoelastic materials that include blood, chocolate syrup, dough, jelly, clay, toothpaste, ketchup, shampoo, cement, and honey.

In computer graphics, various methods of fluid simulation are being developed, and active research is currently being carried out on simulations of viscoplastic or viscoelastic fluids that are non-Newtonian fluids. Methods of fluid simulation are classified into a grid-based Lagrangian method and particle-based Eulerian method. Since the grid-based Lagrangian method and the particle-based Eulerian method each has its advantages and disadvantages, they complement each other.

Of these methods, a particle based viscoelastic fluid simulation method related to the present disclosure will now be described.

First, a method using a mass-spring model widely applied to model particles will now be described. In this method, elasticity is expressed by adjusting the positions of particles in proportion to a relationship L-γ between the rest length L of a spring used for connecting neighboring particles and the distance γ between the particles. That is, as in the tendency of a spring to retain a constant length, particles that approach each other tend to push against each other, and particles that move apart from each other tend to attract each other. Plasticity is expressed in terms of spring rest length modification based on whether particles are strained or compressed. Viscosity is expressed as a smoothing effect on velocity by viscosity, in terms of impulse force based on the relationship between the positions and relative velocities of particles, only in the case when the particles are approaching each other. In this method, because a spring is inserted or removed according to particle arrangement, and a spring inserted between two particles is used to control characteristics of a viscoelastic fluid, the method has limitations in generally modeling the motion characteristics of a viscoelastic fluid.

Secondly, a method directly following an SPH method employs a co-rotational Maxwell viscoelastic model, and uses a Poisson equation solution to calculate pressure. This method uses a particle re-sampling method such as down-sampling and up-sampling to uniformly distribute particles, thus addressing non-realistic particle clustering due to irregular particle distribution that is a limitation of particle based methods. Down-sampling is an operation of putting two particles together when the distance between the particles is less than a reference value, and up-sampling is an operation of detecting a region where particle distribution is thin to insert particles into the region, thus maintaining uniform distances between the particles. When a material is strained, particle clustering that is prominent especially in viscoelastic materials frequently occurs, and applying the method here gives good visual result. However, in this method, a particle is added and removed on an arbitrary reference values, which limits the ability to generally model the characteristics of a viscoelastic fluid.

Thirdly, a SPH method is a particle-based viscoelastic fluid simulation method that is researched in non-Newtonian fluid mechanics. In this SPH method, it was discovered that expression of free surfaces of a viscoelastic fluid is difficult due to tensile instability, and artificial stress is added to address this limitation and is applied to a two-dimensional simulation. Thus, the simulation is performed without cracks on a free surface. However, a free surface of a fluid is simulated without using plasticity. It is difficult to apply this method to various viscoelastic fluids. In addition, complicated numerical formulas are required to apply artificial stress used in this method to a three-dimensional simulation, and thus, the calculation load unnecessarily increases

### SUMMARY

In one general aspect, a fluid simulation method of simulating a flow of a viscoelastic fluid on the basis of a particle-based smoothed particle hydrodynamics (SPH) method includes: adding an artificial force related with viscosity of the viscoelastic fluid, an artificial force related with elasticity of the viscoelastic fluid, and an artificial force related with plasticity of the viscoelastic fluid to a momentum equation of the viscoelastic fluid.

The fluid simulation method may further include applying Von Mises yield criteria to an Oldroyd-B model with respect to the artificial force related with the plasticity.

In another general aspect, a fluid simulation method of simulating a flow of a viscoelastic fluid on the basis of a particle-based smoothed particle hydrodynamics (SPH) method includes: adding an artificial force related with viscosity of the viscoelastic fluid to a momentum equation of the viscoelastic fluid; adding an artificial knee related with elasticity of the viscoelastic fluid to the momentum equation of the viscoelastic fluid; and adding an artificial force related with plasticity of the viscoelastic fluid to the momentum equation of the viscoelastic fluid.

In another general aspect, an apparatus simulating a flow of a viscoelastic fluid on the basis of a particle-based smoothed particle hydrodynamics (SPH) method, adds an artificial force related with viscosity of the viscoelastic fluid, an artificial force related with elasticity of the viscoelastic fluid, and an artificial force related with plasticity of the viscoelastic fluid to a momentum equation of the viscoelastic fluid.

Other features and aspects will be apparent from the following detailed description, the drawings, and the claims.

### BRIEF DESCRIPTION OF THE DRAWINGS

FIGS. 1A to 1D are images illustrating results of dropping simulation of cubic viscoelastic fluids using a method of simulating a viscoelastic fluid according to an exemplary embodiment.

FIGS. 2A to 2F are images illustrating results of parameter-variable simulation of fluids having an identical viscosity, which uses a method of simulating a viscoelastic fluid according to an exemplary embodiment.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings. According to the present invention, in fluid simulation based on a smoothed particle hydrodynamics (SPH) method, three forces referred to as artificial forces, that is, a force related with viscosity, a force related with elasticity, and a force related with plasticity added in solving a momentum equation of SPH to express characteristics of viscosity, elasticity and plasticity in vicoelastic fluid simulation.

Hereinafter, basic equations of the SPH method, main equations of a viscoelastic fluid, and the added artificial forces will now be described in detail.

(1) Fluid Basic Equation

Two main equations for expressing a motion of fluid are a continuity equation and a momentum equation, which are expressed as Equation (1) and Equation (2) below.

$$\begin{matrix}\frac{D ρ}{Dt} = - ρ \frac{\partial {v}^{β}}{\partial {x}^{β}} & [ Equation 1 ] \\ \frac{{Dv}^{α}}{Dt} = \frac{1}{ρ} \frac{\partial {σ}^{αβ}}{\partial {x}^{β}} + {F}^{α} & [ Equation 2 ]\end{matrix}$$

where v, ρ, σ, and F denote velocity, density, a total stress tensor, and external force, respectively. α and β are components of a tensor (α, β), and β denotes a β^{th} component of a vector.

The total stress tensor is expressed using a pressure p of a particle and a viscous stress tensor τ as expressed by Equation (3) below.

σ^{αβ}=−pδ^{αβ}+τ^{αβ} [Equation 3]

Since the present disclosure relates to the momentum equation, the momentum equation will now be described. When particle approximation of SPH is applied to Equation (2), Equation (4) with respect to a particle i may be obtained.

$$\frac{{Dv}_{i}^{α}}{Dt} = {Σ}_{j} {m}_{j} ( \frac{{σ}_{i}^{αβ}}{{ρ}_{i}^{2}} + \frac{{σ}_{j}^{αβ}}{{ρ}_{j}^{2}} ) \frac{\partial {w}_{ij}}{\partial {x}_{ij}^{β}} + {F}^{α} \qquad [ Equation 4 ]$$

where W denotes a smoothing function, and mⱼ is denotes the mass of a neighbor particle j.

(2) Viscoelastic Fluid Model

τ is a non-linear function of the rate of strain tensor in a non-Newtonian fluid. In the present disclosure, the Oldroyd-B model, expressing the Upper Convected Maxwell (UCM) model by adjusting a parameter, is used to express various viscoelastic fluids. A constitutive equation is expressed as Equation 5 below.

$${τ}^{αβ} + {λ}_{1} {τ}^{{αβ}^{∇}} = η ( {d}^{αβ} + {λ}_{2} {d}^{{αβ}^{∇}} ) \qquad [ Equation 5 ]$$

where η, λ₁, and λ₂ denote fluid viscosity, a time constant of relaxation, and a time constant of retardation, respectively. d^{αβ} denotes the rate of strain tensor, and ∇ denotes an upper-convected derivative.

From the Equation 5, τ may be expressed by Equation 6 and Equation 7 below.

$$\begin{matrix}{τ}^{αβ} = η ( \frac{{λ}_{2}}{{λ}_{1}} ) {d}^{αβ} + {S}^{αβ} & [ Equation 6 ] \\ {S}^{αβ} + {λ}_{1} {S}^{{αβ}^{∇}} = η ( 1 - \frac{{λ}_{2}}{{λ}_{1}} ) {d}^{αβ} & [ Equation 7 ]\end{matrix}$$

where S^{αβ} denotes a non-Newtonian condition in τ.

When the particle approximation of SPIT is applied to Equation 7, Equation 8 with respect to the particle i is as follows.

$$\frac{{DS}_{i}^{αβ}}{Dt} = {K}_{i}^{αγ} {S}_{i}^{γβ} + {K}_{i}^{βγ} {S}_{i}^{αγ} - \frac{1}{{λ}_{1}} {S}_{i}^{αβ} + \frac{η}{{λ}_{1}} ( 1 - \frac{{λ}_{2}}{{λ}_{1}} ) {d}_{i}^{αβ} \\ where {d}_{i}^{αβ} = {K}_{i}^{αβ} + {K}_{i}^{βα} , and {K}_{i}^{βα} = {( \frac{\partial {v}^{α}}{\partial {x}^{β}} )}_{i} . \qquad [ Equation 8 ]$$

(3) Artificial Forces

In addition to the continuity equation Equation 1 and the momentum equation Equation 2, all forces applied to a particle are considered as artificial forces in the present disclosure.

(3-1) Plasticity Yield

Plasticity yield is caused by a force related with plasticity. According to the present disclosure, Von Mises yield criteria used in a grid based method is applied to the particle based method and the Oldroyd-B model.

Plasticity is the property of a material to undergo non-reversible change of shape even after external force causing the deformation is removed. Plasticity is exhibited when the greater force than an elastic limit is applied to a material. The transition from elastic behavior to plastic behavior is called yield. The Von Mises yield criteria are used to determine whether a material yields or not. According to the Von Mises yield criteria, when Von Mises stress ρᵥ of Equation 9 reaches a yield strength ρ_{y} or an arbitrary threshold called an elastic limit, the yield of a material starts.

$${σ}_{v} = \sqrt{\frac{3}{2} {k}_{ij} {k}_{ij}} \qquad [ Equation 9 ]$$

where kᵢⱼ is a component of a stress deviator tensor ρ^{dev} shown in Equation 10 below.

$${σ}^{dev} = σ - \frac{1}{3} ( σ \cdot I ) I \qquad [ Equation 10 ]$$

Since the time constant λ₂ is very small or zero in the present disclosure, ρ^{dev} may be calculated from a non-Newtonian element of a viscous stress tensor by using Equation 11 below.

$${σ}^{dev} = S - \frac{1}{3} ( S \cdot I ) I \qquad [ Equation 11 ]$$

Thus, a Von Mises yield condition may be used by replacing S of Equation 8 with S′ of Equation 12.

$${S}^{′} = S \frac{max ( 0 , {σ}_{v} - {σ}_{y} )}{{σ}_{v}} \qquad [ Equation 12 ]$$

Thus, as ρ_{y} is increased, the elastic limit is increased.

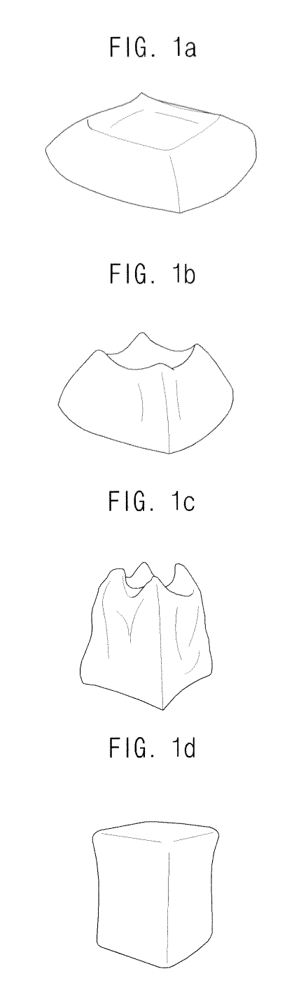

FIGS. 1A to 1D are images illustrating results of dropping simulation of cubic viscoelastic fluids using a method of simulating a viscoelastic fluid according to an exemplary embodiment.

Referring to FIGS. 1A to 1D, plasticity is well controlled. A cubic viscoelastic fluid of FIG. 1D has a great elastic limit value, and thus it is not deformed by a floor collision force, and the floor collision force functions as a bouncing force. A cubic viscoelastic fluid of FIG. 1C has a less elastic limit value than that of the cubic viscoelastic fluid of FIG. 1D. In this case, the cubic viscoelastic fluid of FIG. 1C is slightly deformed, the rest force functions as a bouncing force. A cubic viscoelastic fluid of FIG. 1A has a small elastic limit value. In this case, the cubic viscoelastic fluid of FIG. 1A is significantly deformed. A cubic viscoelastic fluid of FIG. 1B has the mean elastic limit value of the elastic limit values of FIGS. 1A and 1C. In this case, the deformation amount is greater than that of FIG. 1C and less than FIG. 1A.

(3-2) Artificial Viscosity

An artificial viscosity force is a force related with viscosity. When particles rapidly approach each other, they may permeate each other, which is a phenomenon against physical phenomena in fluid simulation using the SPH method. To prevent this phenomenon and perform shock wave simulation, the artificial viscosity force as expressed by Equation 13 is developed and widely used. The Monaghan method is used in the current embodiment. Since the Monaghan method is widely used for artificial viscosity, a description thereof will be omitted.

$${⋂}_{ij} = \{ \begin{matrix}\frac{- {α}_{⋂} {c}_{ij} {φ}_{ij} + {β}_{⋂} {φ}_{ij}^{2}}{{ρ}_{ij}} & {v}_{ij} \cdot {x}_{ij} < 0 \\ 0 & {v}_{ij} \cdot {x}_{ij} \geq 0\end{matrix} \\ {φ}_{ij} = \frac{{hv}_{ij} \cdot {x}_{ij}}{{\vert {x}_{ij} \vert}^{2} + {φ}^{2}} \qquad [ Equation 13 ]$$

where α_{∩} and β_{∩} are constants close to 1.0.

The artificial viscosity force may be used by adding a term including ∩ᵢⱼ as expressed by Equation 14 to Equation 7.

$$\frac{{σ}_{i}^{αβ}}{{ρ}_{i}^{2}} + \frac{{σ}_{j}^{αβ}}{{ρ}_{j}^{2}} + {⋂}_{ij} {δ}^{αβ} \qquad [ Equation 14 ]$$

Of the above constants β_{∩} functions as a main part for preventing a non-realistic particle permeation when particles rapidly approach each other, and α_{∩} is a value related with shear and bulk viscosity and may be zero. α_{∩} is more important than β_{∩} in viscoelastic fluid simulation. According to the present invention, it was discovered that the term α_{∩} is a necessary part in maintaining particles methodical and in maintaining system stable.

(3-3) Artificial Tensile Stress

When compressive force is applied to a material, repulsive force is applied between particles to push the particles against pressure. On the contrary, when a material is pulled or extended, attractive force is applied between particles and resistant to extension. The attractive force clusters particles together, and make a system unstable, which is referred to as tensile instability. Repulsive force may be added to address the tensile instability. According to the present invention, it was discovered that the Monaghan method may be applied to three-dimensional viscoelastic fluid simulation, which produced good visible results. Particle clustering is more prominent in materials having high elasticity. Thus, an artificial tensile stress is also used to control elasticity in the present disclosure.

Equation 14 may be replaced with Equation 15 below to add an artificial tensile stress term.

$$\frac{{σ}_{i}^{αβ}}{{ρ}_{i}^{2}} + \frac{{σ}_{j}^{αβ}}{{ρ}_{j}^{2}} + {⋂}_{ij} {δ}^{αβ} + {R}_{ij}^{αβ} {f}_{ij}^{n} \qquad [ Equation 15 ]$$

where Rᵢⱼ^{αβ}=Rᵢ^{αβ}+Rⱼ^{αβ} is artificial stress, and Rᵢ^{αβ} and Rⱼ^{αβ} are calculated using Equation 16 below.

$${R}_{i}^{αβ} = \{ \begin{matrix}- ε \frac{{σ}_{i}^{αβ}}{{ρ}^{2}} & if {σ}_{i}^{αβ} > 0 \\ 0 & if {σ}_{i}^{αβ} \leq 0\end{matrix} \qquad [ Equation 16 ]$$

where ε determines intensity of the artificial stress, and fᵢⱼⁿ determines an application range of the artificial stress, which is expressed as Equation 17 below.

$${f}_{ij}^{n} = {( \frac{{w}_{ij}}{w ( Δ d )} )}^{n} \qquad [ Equation 17 ]$$

where n>0, and Δd is the size of a mean particle.

According to Equation 17, as the distance between two particles is reduced, repulsive force is quickly increased. As the distance between two particles is greater than a smoothing length h, repulsive force is quickly decreased. Thus, the artificial stress is disposed within the range of h.

(4) Simulation of Various Viscoelastic Fluids

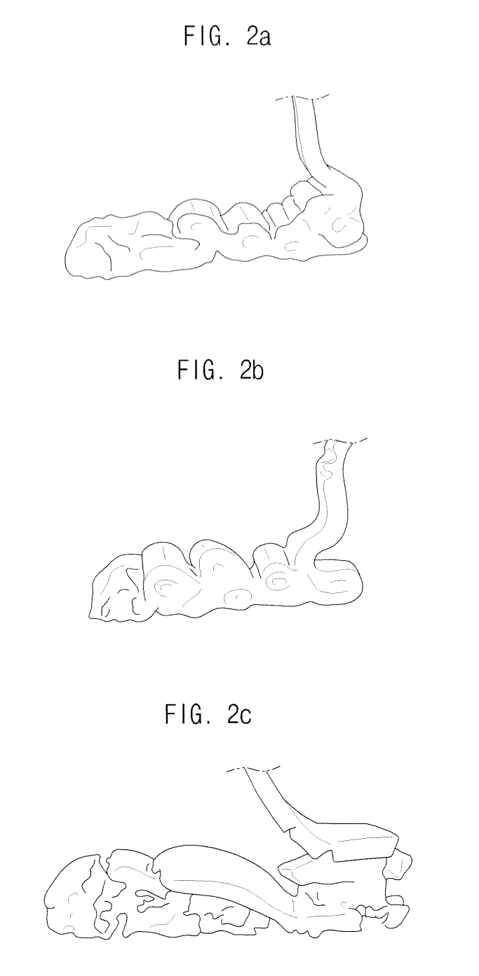

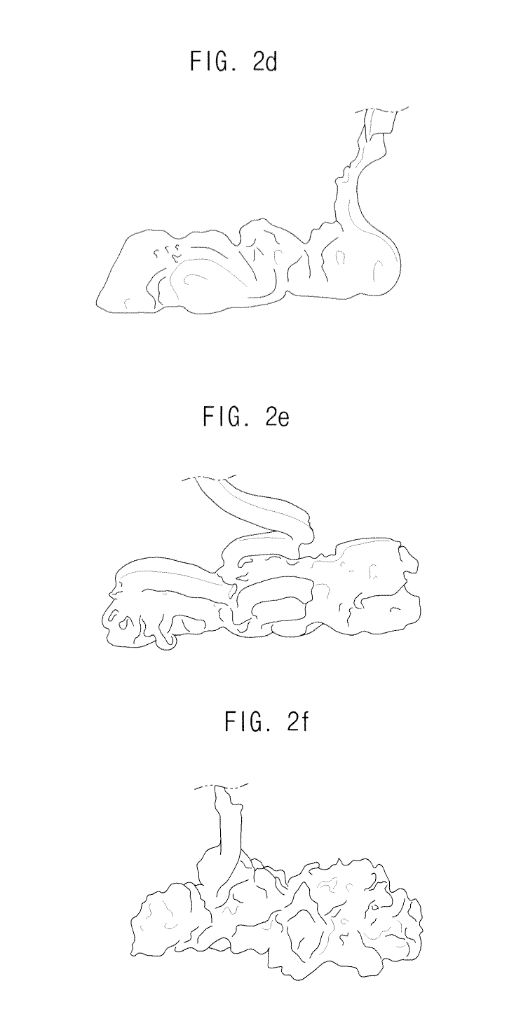

FIGS. 2A to 2F are images illustrating results of parameter-variable simulation of fluids having an identical viscosity, which uses a method of simulating a viscoelastic fluid according to an exemplary embodiment. Referring to FIGS. 2A to 2F, a density value and parameters applied to artificial forces for viscosity, elasticity, plasticity are adjusted to exhibit various effects. A time constant of relaxation ranging from 0.01 to 0.3, a time constant of retardation ranging from 0.001 to 0.03, and an artificial stress parameter value ranging from 0.1 to 0.5 were used in the simulation.

The invention can also be embodied as computer readable codes on a computer-readable storage medium. The computer-readable storage medium is any data storage device that can store data which can be thereafter read by a computer system. Examples of the computer-readable storage medium include ROMs, RAMs, CD-ROMs, DVDs, magnetic tapes, floppy disks, registers, buffers, optical data storage devices, and carrier waves (such as data transmission through the Internet). The computer-readable storage medium can also be distributed over network coupled computer systems so that the computer readable codes are stored and executed in a distributed fashion. Also, functional programs, codes, and code segments for accomplishing the present invention can be easily construed by programmers skilled in the art to which the present invention pertains.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A fluid simulation method of simulating a flow of a viscoelastic fluid on the basis of a particle-based smoothed particle hydrodynamics (SPH) method, the fluid simulation method comprising:
adding an artificial force related with viscosity of the viscoelastic fluid, an artificial force related with elasticity of the viscoelastic fluid, and an artificial force related with plasticity of the viscoelastic fluid to a momentum equation of the viscoelastic fluid.

2. The fluid simulation method of claim 1, wherein applying Von Mises yield criteria to an Oldroyd-B model with respect to the artificial force related with the plasticity.

3. A fluid simulation method of simulating a flow of a viscoelastic fluid on the basis of a particle-based smoothed particle hydrodynamics (SPH) method, the fluid simulation method comprising the steps of:
adding an artificial force related with viscosity of the viscoelastic fluid to a momentum equation of the viscoelastic fluid;
adding an artificial force related with elasticity of the viscoelastic fluid to the momentum equation of the viscoelastic fluid; and
adding an artificial force related with plasticity of the viscoelastic fluid to the momentum equation of the viscoelastic fluid.

4. An apparatus simulating a flow of a viscoelastic fluid on the basis of a particle-based smoothed particle hydrodynamics (SPH) method, the apparatus adding an artificial force related with viscosity of the viscoelastic fluid, an artificial force related with elasticity of the viscoelastic fluid, and an artificial force related with plasticity of the viscoelastic fluid to a momentum equation of the viscoelastic fluid.
